(19) United States
(12) Patent Application Publication
(10) Pub. No.: US 2012/0063656 A1
(43) Pub. Date: Mar. 15, 2012

(54) EFFICIENT MAPPING OF TISSUE PROPERTIES FROM UNREGISTERED DATA WITH LOW SIGNAL-TO-NOISE RATIO

(75) Inventors: Terrence JAO, Los Angeles, CA (US); Zungho ZUN, Mountain View, CA (US); Krishna NAYAK, Los Angeles, CA (US)

(73) Assignee: UNIVERSITY OF SOUTHERN CALIFORNIA, Los Angeles, CA (US)

(21) Appl. No.: 13/231,741

(22) Filed: Sep. 13, 2011

Related U.S. Application Data
(60) Provisional application No. 61/403,262, filed on Sep. 13, 2010.

(51) Int. Cl. G06K 9/46; G06K 9/00

(52) U.S. Cl. 382/128; 382/201

(57) ABSTRACT

Image processing methods are described that include segmenting boundaries of a region of interest (ROI) and identifying one or more control points, in each of multiple images of the same object, region, or location. The coordinates of each image are transformed from image coordinates into a coordinate frame relative to the control point or points. Image data is resampled and filtered and/or averaged. One or more material properties can be calculated from the resampled and filtered image data and then displayed. Alignment of unregistered image data of multiple images of the same object, region, or location is provided. Applications are described for medical imaging.

### RELATED APPLICATION

This application claims priority to and benefit of U.S. Provisional Patent Application Ser. No. 61/403,262 filed Sep. 13, 2010, Attorney Docket No. 028080-0604, and entitled “Efficient Mapping of Tissue Properties From Unregistered Data With Low Signal-to-Noise Ratio,” the entire content of which is incorporated herein by reference.

### BACKGROUND

The evolution of medical imaging systems has progressively moved away from simple anatomic imaging towards functional imaging, which can detect and even quantify changes in various tissue properties, including metabolism, blood flow, and absorption. For example, functional imaging typically employs imaging modalities that utilize tracers or contrast agents to detect physiological activities of tissues and organs over a time and with multiple successive images.

Recent advances have yielded new techniques, such as arterial spin labeling (ASL), that no longer require these extrinsic agents, albeit at the cost of lower signal-to-noise. Regardless of the imaging modality or technique employed in functional imaging, reliable measurements of tissue properties can require successive images at the same anatomic location. This can make them susceptible to error resulting from image misalignment due to patient movement, respiratory/cardiac motion, and other sources of physiologic motion.

### SUMMARY

Image processing techniques according to the present disclosure can provide for the alignment of unregistered image data of multiple images of the same object, region, or location. The techniques can increase the signal-to-noise ratio (SNR) of the images.

An aspect of the present disclosure is directed to a general image processing method that includes segmenting boundaries of a region of interest (ROI) and identifying one or more control points, in each of multiple images of the same object, region, or location. The coordinates of each image are transformed from image coordinates into a coordinate frame relative to the control point or points. Image data is resampled and filtered and/or averaged. One or more material properties can be calculated from the resampled and filtered image data and then displayed.

A further aspect of the present disclosure is directed to an imaging and display system to implement methods according to the present disclosure. An imaging system provides unregistered imaging data to a memory unit and processor. The memory unit and/or processor may be connected to a display.

Exemplary embodiments are directed to medical imaging and may utilize any type of medical imaging modalities.

These, as well as other components, steps, features, benefits, and advantages of the present disclosure, will now become clear from a review of the following detailed description of illustrative embodiments, the accompanying drawings, and the claims.

### BRIEF DESCRIPTION OF THE DRAWINGS

The drawing figures depict one or more implementations in accord with the present teachings, by way of example only, not by way of limitation. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps. The drawings are not necessarily to scale, emphasis instead being placed on the principles of the disclosure. In the drawings:

FIG. 1 depicts a flow chart for an image processing technique according to the present disclosure.

FIG. 2 is an image depicting segmentation and control point identification for a region of interest according to the present disclosure.

FIG. 3 is a plot depicting resampled data according to the present disclosure.

FIG. 4 is a data display representing perfusion reserve data from a patient with total occlusion of the right coronary artery.

FIG. 5 is a graph showing MBF data from a short axis slice of the heart displayed on the left ventricular segementation model with three myocardial layers.

FIG. 6 depicts a basic system suitable to implement methods according to the present disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Aspects of the present disclosure provide simple and effective methods that align unregistered image data and boost the signal-to-noise ratio (SNR) of low SNR imaging techniques, such as functional imaging or other types of imaging. After performing quantitative analysis of the desired property (e.g., a tissue property or property of other type of material) on the aligned images, the data can be mapped and displayed in a form that can be easily interpreted.

As is described below, exemplary embodiments are directed to medical imaging such as functional imaging of the heart. The scope of the present disclosure is not limited to medical imaging, however, and other imaging techniques may be utilized and non-medical subjects may be imaged.

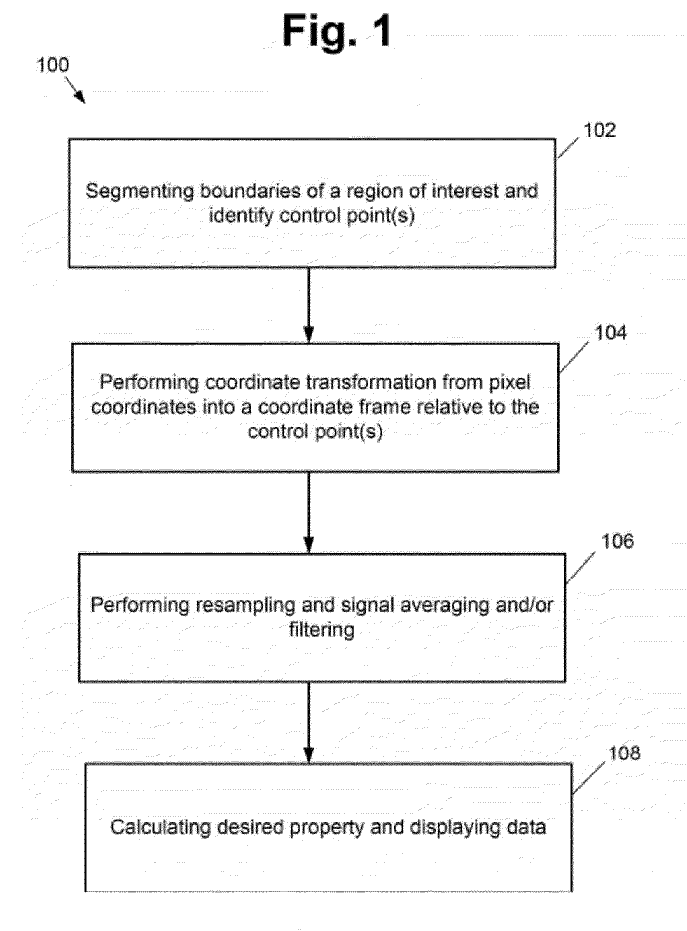

FIG. 1 is a flow chart of a general image processing method 100 according to the present disclosure. Method 100 includes segmenting boundaries of a region of interest (ROI) and identifying one or more control points, in multiple images of the same object, region, or location as described at 102. The segmentation may be performed manually, e.g., by a user, or automatically, such as by operation of suitable software or a suitably programmed processor. For the segmentation, boundaries of a region of interest (ROI) are segmented on all images to be analyzed, creating a binary mask of the ROI. The control points are geometric points that define the particular geometry of a ROI, e.g., an organ, for coordinate transformation. Any suitable geometry may be used for a ROI. Examples include, but are not limited to, circular, spherical, ellipsoidal, prolate spheroidal, obloate spheroidal, cylindrical, and the like. The one or more control points can then be manually chosen or calculated from the ROI.

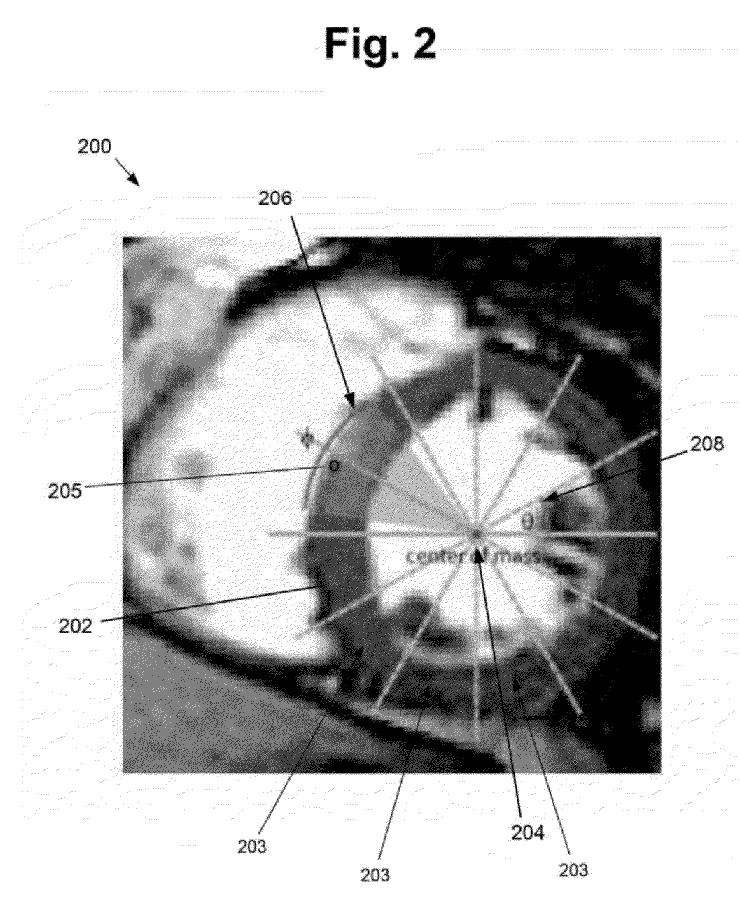

An example of step 102 as applied to myocardial ASL is shown in FIG. 2, which depicts an image 200 of a short-axis slice of the left ventricular myocardium and adjacent tissue of a test subject. The region of interest (ROI) 202 is selected to be the left ventricular muscle, which is shaded as the toroidal region at the right. The ROI 202 is segmented into a selected number (e.g., 12) of segments 203 by segmentation lines, as shown. One control point 204 can be selected to be the center of mass of the left ventricle, and can be computed automatically or by a user. A second control point can be manually identified by the user or automatically selected, e.g., control point 205 at the middle of the ventricular septum. A defined (by a user or automatically such as by software) window 206 is shown. Uniformly spaced intervals 208 are shown (uniform in angle or arc length).

Returning to FIG. 1, further for method 100, a coordinate transformation takes place, as described at 104. For this, pixels of the image within the ROI are transformed from image coordinates into a coordinate frame relative to the control point or points. The ROI of each image is consequently in a common coordinate frame, which corrects for misalignment from image to image, e.g., as caused by in-plane translation and rotation of organs, or other objects.

An example of step 104 as applied to myocardial ASL, such as shown in FIG. 2, is to transform pixel data within the ROI 202 from rectangular coordinate into polar coordinates using the center-of-mass 204 as a reference point, and with rotational correction based on the control point 205 within the septal wall.

Further for method 100, image data is resampled and filtered and/or averaged, as described at 106. Image data may become irregularly spaced in the new coordinate frame, e.g., arising from a transformation from rectangular to polar coordinates. It is desirable therefore to resample such data in order to facilitate analysis and display. Each resampled data point can be computed as a weighted average of pixel intensities within a user defined (or, automatically defined) spatio-temporal window that is centered about that point. Many filters can be chosen. Exemplary filters include, but are not limited to, those that follow a standard window such as the Gaussian, Hamming, Hanning, Kaiser-Bessel, etc. In many embodiments, data points further from the center of the window will have a smaller contribution than more central data points.

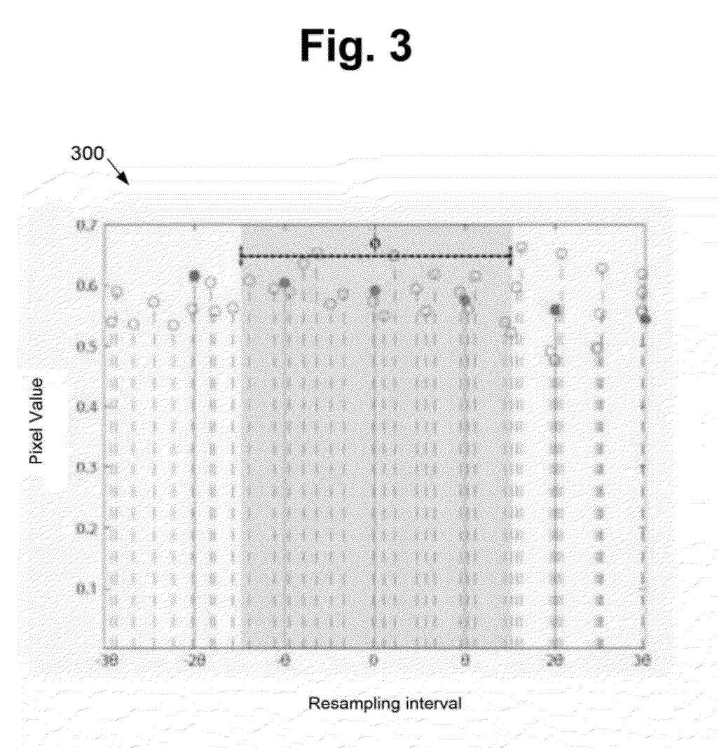

An example of the resampling and filtering of step 106 as applied to myocardial ASL is shown in FIG. 3, which depicts a table 300 showing an example of resampling of data after coordinate transformation for the image of FIG. 2. In table 300, the dotted lines represent the irregularly spaced image data (derived from FIG. 2) after coordinate transformation. The solid lines with solid circles at the top represent the resampled data. The shaded region represents a window of size Φ centered at θ=0. The resampled data at θ=0 is a weighted average of the image data within the window.

Continuing with the description of method 100 of FIG. 1, one or more material properties can be calculated from the resampled and filtered image data and then displayed, as described at 108. After data resampling and filtering, the desired material property can be calculated and visualized in a format that facilitates interpretation. Any material property that can be determined from image data may be calculated. Examples include, but are not limited to, material or tissue density, hardness, composition, absorption, and the like. Tissue properties that can be determined include but are not limited to density, hardness, composition, type, blood flow/perfusion, and the like.

An example of step 108, e.g., as derived from an image of the left ventricle such as shown in FIG. 2, is shown an described below for FIG. 5. For such, myocardial blood flow can then be calculated from resampled data, spaced and angular distance, θ, apart. Only pixels within the ROI and a defined (user-defined or automatically defined) window, Φ, contribute to the MBF calculation. The choice of window size, Φ, impacts the angular spatial resolution of transformed image and related calculated property(ies), e.g., myocardial blood flow maps. The choice of resampling interval, θ, and window size, Φ, are independent of one another.

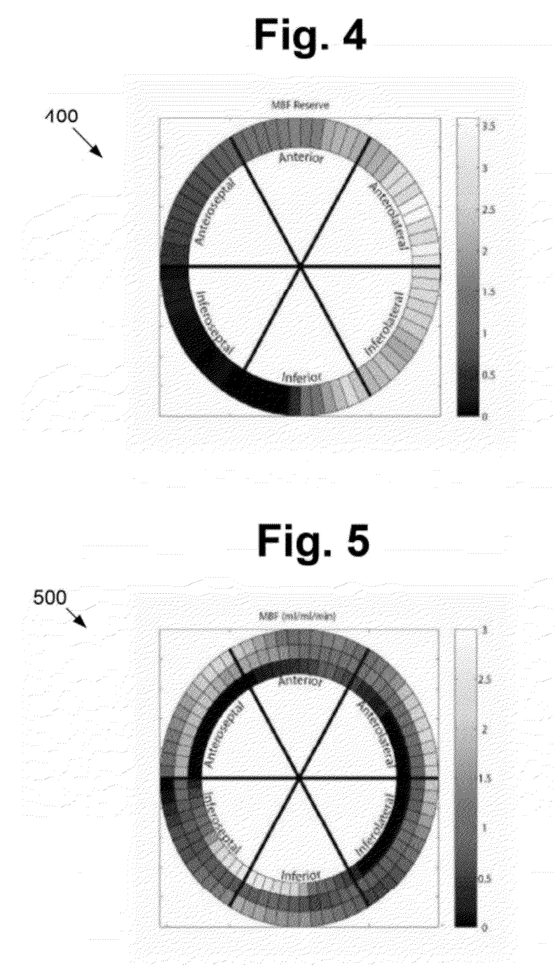

In myocardial perfusion imaging, MBF data is displayed on an annular ring to match the corresponding slice—basal, mid, or apical—of the standard left ventricular segmentation model. The 17-segment model of the left ventricle has been adopted by the American Heart Association to provide a standard for clinicians to assess and interpret myocardial perfusion, left ventricular function, and coronary anatomy from tomographic images of the heart. FIG. 4 is a data display 400 representing perfusion reserve data from a patient with total occlusion of the right coronary artery. The displayed quantity is MBF measured during adenosine infusion divided by MBF measured at rest. This quantity is indicative of myocardial ischemia. By displaying the data on the 17-segment model, physicians can easily see a lack of perfusion of the myocardium supplied by the right. In FIG. 4, data from only the basal slice is plotted.

An exemplary embodiment can be implemented for myocardial perfusion imaging, as shown in FIG. 5, which is a is a graph 500 showing MBF data from a short axis slice of the heart (such as shown in FIG. 2) displayed on the left ventricular segementation model with three (3) myocardial layers.

As shown in FIG. 5, the left ventricular wall can be divided into multiple layers in order to analyze the MBF of different myocardial layers. Techniques of the present disclosure can perform layer division by calculating the radial distance of voxels within the left ventriclular myocardium of a small region, AO. In the same way, other objects or regions may be divided into layers for image analysis. Within AO, maximum and minimum radial distance of the voxels can be found so as to determine the radial range. Voxels with radii in the upper half or third of the radial range can be classified as the subepicardium in a two or three layer division respectively. Similarly, voxels with radii in the lower half or third of the radial range can be classified as the subendocardium. This algorithm can be repeated for the entire circumference of the left ventriclular slice such that all voxels within the left ventricular myocardium are classified by layer. Subsequent signal averaging, e.g., as described above, can be prescribed to determine the MBF of the different myocardial layers and subsequently displayed on the 17-segment model.

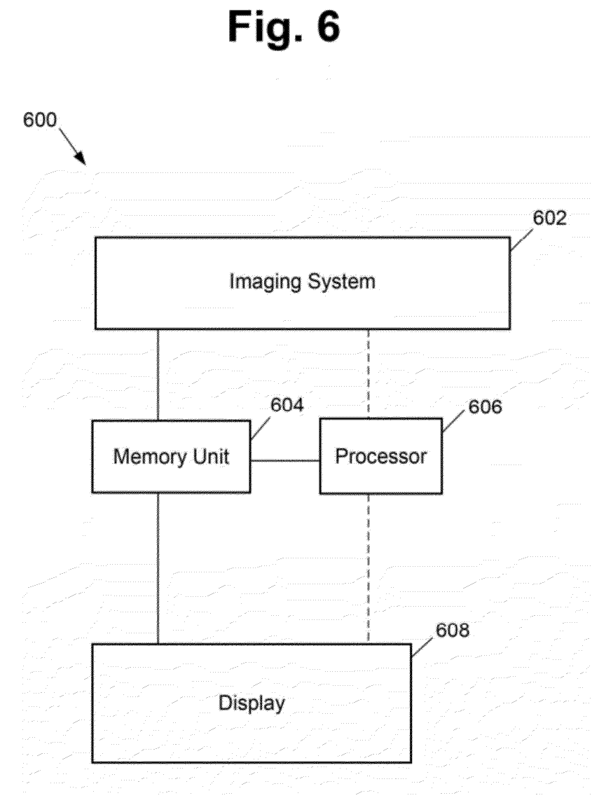

FIG. 6 depicts a basic system 600 suitable to implement methods according to the present disclosure. An imaging system 602 can provide unregistered imaging data, e.g., such as medical imaging data, to a memory unit 604 and processor 606. Any suitable imaging system may be utilized as imaging system 602. Examples include, but are not limited to, MRI, CT, X-ray, visible light, infrared, ultraviolet, and ultrasound, as well as suitable combinations of such. The memory unit 604 and/or processor may be connected to a display 608 as shown. Any suitable memory unit, e.g., amount of RAM and/or ROM, may be used. Further, any suitable processor 606 may be used. For example, the processor 606 may be a general central processing unit (CPU) or a graphics-specialized graphics processing unit (GPU). Of course, the architecture for the system 600 is flexible, and the processor 606 may optionally be directly coupled to imaging system and/or display 608. Any suitable display, of any suitable size and/or type, may be used for display 608.

The processor 606 may include or run suitable software (programming, or computer-readable instructions resident in a computer-readable storage medium) for image processing. Examples of suitable imaging software include but are not limited to MATLAB, e.g., MATLAB Release 2011b, as made commercially available by the MathWorks, and Interactive Data Language (IDL), e.g., IDL version 8, as made commercially available by ITT Visual Information System. Such software, when appropriately modified or programmed to carry out techniques such as shown and described for FIG. 1, may implement embodiments of the present disclosure.

Accordingly, the techniques as described herein can offer advantages and improvements over other methods of addressing image misregistration.

For example, image misalignment caused by patient movement and other sources of physiologic motion is a common problem in time-series data. Techniques, such as described for FIG. 1, can analyze misaligned medical imaging data when a region of interest is defined. In the clinical setting, this can allow a user to analyze data with large bulk motion, data from patients that cannot reduce respiratory movement through breatholds, and data from patients that are unable to remain still for long periods of time, such as children.

Techniques as described herein can also provide for increased SNR. In low SNR imaging techniques, noise is often a problem that can corrupt the quality of data. High noise limits both the sensitivity and specificity of functional imaging to detect disease and pathology. Therefore, noise reduction is critical for clinical application. A common method to increase SNR is through temporal signal averaging of many image samples. A large number of samples, however, can be impractical in imaging techniques with long image acquisition times and degrades temporal resolution. Techniques of the present disclosure can increase SNR through both spatial and temporal signal averaging, giving the user more flexibility in choosing a balance between temporal and spatial resolution.

Exemplary embodiments can provide for transmural heterogeniety of the left ventricular wall. Irreversible ischemic injury to the myocardium is described as a transmural wavefront, beginning in the subendocardium. As the duration of ischemia increases, this wavefront of necrosis spreads to involve more of the transmural thickness of the left ventricle, eventually involving the entire transmural thickness. Most myocardial perfusion scans, however, are unable to analyze MBF by myocardial layer. By providing the ability to assess MBF by myocardial layers, techniques of the present disclosure may afford or facilitate the early detection of ischemic injury.

The techniques of the present disclosure are general enough such that they can be implemented using any medical imaging modality, including, but not limited to MRI, CT, X-ray, and ultrasound, as well as imaging techniques utilizing visible light, infrared light, and/or ultraviolet light, e.g., spectroscopic techniques. Consequently, this invention can be used to analyze and quantify functional imaging data of any tissue property at any anatomic location that medical imaging can perform. This includes imaging blood flow, oxygenation, glucose, metabolism, chemical composition, absorption, and any other physiological activity that can be functionally imaged.

In addition to application to medical imaging, the techniques of the present disclosure are general enough such that they can be implemented using other imaging modalities and for non-medical imaging as well. For example, techniques of the present disclosure may be used with MRI, CT, X-ray, and ultrasound imaging used on non-living matter, such as luggage, cargo containers, etc.

As described previously, techniques of the present disclosure may utilize signal averaging and filtering in order to improve the SNR of low SNR imaging techniques. The specific choice of filter is not limited and the user may decide which filter best suits his or her needs (or that choice may be made for the user). The choice of window size, shape, and dimension to perform signal averaging and filtering is also arbitrary and up to the user (or those choices made for the user). For example, embodiments can be implemented in three dimensions with a window that designates a volume of interest and a filter defined along all three physical axes.

Accordingly, techniques of the present disclosure provide for alignment of unregistered image data, an increase of the SNR of low SNR imaging techniques, and the display of imaging (e.g., functional medical imaging) data that facilitates interpretation (e.g., clinical interpretation). Exemplary embodiments have been applied to myocardial perfusion imaging using ASL MRI and may be used to successfully detect single vessel disease.

Aspects of the methods of image processing outlined above may be embodied in programming. Program aspects of the technology may be thought of as “products” or “articles of manufacture” typically in the form of executable code and/or associated data that is carried on or embodied in a type of non-transitory machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer, processor, or device into another, for example, from a management server or host computer of the service provider into the computer platform of the application server that will perform the function of the push server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s), server(s), or the like, such as may be used to implement the push data service shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for aligning unregistered image data, the system comprising:
a memory;
a processor connected to the memory; and
programming for execution by the processor, stored in the storage device, wherein execution of the programming by the processor configures the system to perform functions, including functions to:
for each of a plurality of images, segmenting boundaries of a region of interest (ROI) and identifying one or more control points for the ROI;
for each of the plurality of images, transforming pixels of the image within the ROI from image coordinates into a coordinate frame relative to the control point or points, forming transformed image data for each image;
resampling and filtering the transformed image data for each image; and
calculating one or more material properties from the resampled and filtered image data.

2. The system of claim 1, wherein the functions further include displaying the one or more calculated material properties.

3. The system of claim 1, wherein the one or more material properties comprise the tissue property of blood flow.

4. The system of claim 3, wherein the blood flow comprises myocardial blood flow (MBF).

5. The system of claim 1, wherein the one or more material properties comprise density.

6. The system of claim 5, wherein the density comprises tissue density.

7. The system of claim 1, wherein segmenting boundaries of a region of interest (ROI) comprises segmenting the boundary of the ROI into a plurality of boundary segments subtended by equal angles.

8. The system of claim 1, wherein segmenting boundaries of a region of interest (ROI) comprises segmenting the boundary of the ROI into a plurality of boundary segments having equal lengths.

9. The system of claim 1, wherein identifying one or more control points for the ROI comprises identifying the center of mass of the ROI as a control point.

10. The system of claim 1, wherein transforming pixels of the image within the ROI from image coordinates into a coordinate frame relative to the control point or points comprises a polar transform.

11. The system of claim 1, wherein transforming pixels of the image within the ROI from image coordinates into a coordinate frame relative to the control point or points comprises a spherical transform.

12. The system of claim 1, wherein resampling and filtering the transformed image data for each image comprises using a Gaussian filter.

13. The system of claim 1, wherein resampling and filtering the transformed image data for each image comprises using a Hamming filter.

14. The system of claim 1, wherein resampling and filtering the transformed image data for each image comprises using a Hanning filter.

15. The system of claim 1, wherein resampling and filtering the transformed image data for each image comprises using a Kaiser-Bessel filter.

16. The system of claim 1, wherein the functions further include defining a region of interest (ROI).

17. The system of claim 16, wherein the ROI is circular.

18. The system of claim 16, wherein the ROI is spherical.

19. The system of claim 16, wherein the ROI is cylindrical.

20. An article of manufacture comprising:
a non-transitory machine-readable storage medium; and executable program instructions embodied in the machine readable storage medium that when executed by a processor of a programmable computing device configure the programmable computing device to:
for each of a plurality of images, segment boundaries of a region of interest (ROI) and identify one or more control points for the ROI;
for each of the plurality of images, transform pixels of the image within the ROI from image coordinates into a coordinate frame relative to the control point or points, forming transformed image data for each image;
resample and filter the transformed image data for each image; and
calculate one or more material properties from the resampled and filtered image data.

21. The article of manufacture of claim 20, wherein the executable program instructions further configure the programmable computing device to display the one or more calculated material properties.

22. The article of manufacture of claim 20, wherein the one or more material properties comprise the tissue property of blood flow.

23. The article of manufacture of claim 20, wherein the one or more material properties comprise density.

24. The article of manufacture of claim 20, wherein the boundaries of the ROI comprise a plurality of boundary segments subtended by equal angles.

25. The article of manufacture of claim 20, wherein the boundaries of the ROI comprise a plurality of boundary segments having equal lengths.

26. The article of manufacture of claim 20, wherein the one or more control points for the ROI comprise the center of mass of the ROI.

27. The article of manufacture of claim 20, wherein the coordinate frame relative to the control point or points comprises a polar coordinate system.

28. The article of manufacture of claim 20, wherein the executable program instructions further configure the programmable computing device to display the calculated one or more material properties.
